(19) United States
(12) Patent Application Publication
(10) Pub. No.: US 2025/0036330 A1
(43) Pub. Date: Jan. 30, 2025

(54) METHOD AND COMMUNICATION SYSTEM

(71) Applicant: BROTHER KOGYO KABUSHIKI KAISHA, Nagoya (JP)

(72) Inventor: Tomohiro INAGAKI, Nagoya (JP)

(21) Appl. No.: 18/760,405

(22) Filed: Jul. 1, 2024

(30) Foreign Application Priority Data
Jul. 28, 2023 (JP) 2023-123614

(51) Int. Cl. G06F 3/12

(52) U.S. Cl. CPC G06F 3/121; G06F 3/1234; G06F 3/1261; G06F 3/1286

(57) ABSTRACT

A method is performed with a first printer and a second printer to be used in place of the first printer. The method includes: outputting, by the first printer, particular information relating to the first printer; receiving, by the second printer, an input of the particular information; acquiring, by the second printer, particular destination information based on the particular information, the particular destination information indicating the first printer in a local area network to which the first printer is connected; setting, by the second printer, the particular destination information as destination information indicating the second printer in the local area network; and transmitting a use stop request from the second printer or a server to the first printer. The use stop request is a request for stopping communication using the particular destination information. The server is configured to communicate with the first printer.

### REFERENCE TO RELATED APPLICATIONS

This application claims priority from Japanese Patent Application No. 2023-123614 filed on Jul. 28, 2023. The entire content of the priority application is incorporated herein by reference.

### BACKGROUND ART

A technique for transferring information of a flat-rate service from one printer to another printer in a communication system is disclosed.

### SUMMARY

For example, in response to a transfer code request from one printer, a server transmits a transfer code to the one printer. The user inputs the transfer code displayed on the one printer to another printer. When the other printer transmits the transfer code input by the user to the server, the server associates information of a flat-rate service with the ID of the other printer.

The present specification discloses a new technique for handing over information relating to a first printer to a second printer.

According to one aspect, this specification discloses a method performed with a first printer and a second printer to be used in place of the first printer. The method includes outputting, by the first printer, particular information relating to the first printer. Thus, the first printer outputs the particular information. The method includes receiving, by the second printer, an input of the particular information. Thus, the second printer receives an input of the particular information. The method includes acquiring, by the second printer, particular destination information based on the particular information. The particular destination information indicates the first printer in a local area network to which the first printer is connected. Thus, the second printer acquires the particular destination information. The method includes setting, by the second printer, the particular destination information as destination information indicating the second printer in the local area network. Thus, the second printer sets the particular destination information as the destination information indicating the second printer. The method includes transmitting a use stop request from the second printer or a server to the first printer. The use stop request is a request for stopping communication using the particular destination information. The server is configured to communicate with the first printer. Thus, the second printer or the server transmits the use stop request to the first printer.

According to the above configuration, the second printer acquires the particular destination information indicating the first printer in the local network based on the particular information output from the first printer, and sets the particular destination information as the destination information indicating the second printer in the local area network. As a result, the second printer takes over the particular destination information. Further, the second printer transmits an execution instruction of the stopping process for stopping communication using the particular destination information to the first printer. This suppresses an inconvenience that the particular destination information becomes destination information indicating both the first printer and the second printer in the local area network, and the same communication as the communication performed with the first printer is performed with the second printer in the local area network.

According to the above configuration, the printer that performs printing based on a print job transmitted from the terminal apparatus is switched from the first printer to the second printer without performing settings for the terminal apparatus.

The technology disclosed in the present specification may be realized in various forms, and may be realized in the form of, for example, a communication system, a server, a printer, a computer program for realizing the apparatus, system, and method, and a computer-readable storage medium in which the computer program is recorded.

### BRIEF DESCRIPTION OF DRAWINGS

FIG. 1 is a block diagram showing a configuration of a system.

FIG. 2A is an explanatory diagram of a management database DB.

FIG. 2B is an explanatory diagram of an information database IBa.

FIG. 2C is an explanatory diagram of an information database IBb.

FIG. 3 is a first sequence diagram of a handover related process.

FIG. 4 is a second sequence diagram of the handover related process.

FIG. 5 is a third sequence diagram of the handover related process.

FIG. 6 is a diagram showing an example of a notification image NI.

FIG. 7 is a sequence diagram of a handover related process.

### DESCRIPTION

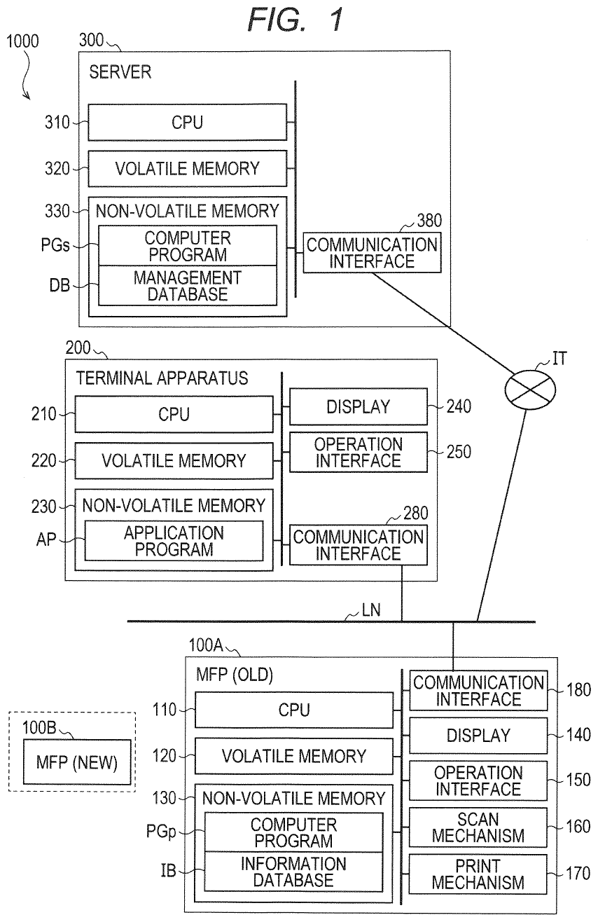

An embodiment of the present disclosure will be described. FIG. 1 is a block diagram showing a configuration of a system 1000. The system 1000 includes multifunction peripherals (MFPs) 100A and 100B, a terminal apparatus 200, and a server 300.

The MFP 100A is a device having a function of performing printing by consuming ink as a printing material and a function of reading a document and generating scan data. The MFP 100A includes a CPU 110 as a controller of the MFP 100A, a volatile memory 120 such as a DRAM, and a non-volatile memory 130 such as a hard disk or a flash memory. The MFP 100A further includes a display 140 such as a liquid crystal display for displaying an image, an operation interface 150 such as a button or a touch panel for acquiring an operation by a user, a scan mechanism (scanner) 160, a print mechanism (print engine) 170, and a communication interface (IF) 180.

The communication interface 180 is an interface for connecting to Internet IT, and is, for example, a wired interface compliant with Ethernet or a wireless interface compliant with the Wi-Fi standard. The “Wi-Fi” is a registered trademark of Wi-Fi Alliance.

The CPU 110 is a computing device (processor) that performs data processing. The volatile memory 120 provides a buffer area for temporarily storing various intermediate data generated when the CPU 110 performs processing. The non-volatile memory 130 stores a computer program PGp for controlling the MFP 100A and an information database IB in which various kinds of service information and setting information described later are stored.

In the present embodiment, the computer program PGp is provided by being stored in advance in the non-volatile memory 130 at the time of manufacturing the MFP 100A. Alternatively, the computer program PGp may be provided in a form of being downloaded from a server connected via the Internet IT or in a form of being recorded on a recording medium such as a CD-ROM.

The CPU 110 executes the computer program PGp to perform various processes for controlling the MFP 100A. For example, the MFP 100A (the CPU 110) controls the print mechanism 170 to print an image. The MFP 100A executes the computer program PGp to communicate with the MFP 100B and the server 300, and performs, for example, a handover related process described later.

The scan mechanism 160 optically reads a document using a one-dimensional image sensor in accordance with the control of the CPU 110, thereby generating scan data indicating an image of the document.

The print mechanism 170 performs printing in accordance with the control of the CPU 110. The print mechanism 170 of the present embodiment is an inkjet print mechanism that prints an image on a recording medium using a plurality of types of ink, for example, four types of ink, cyan (C), magenta (M), yellow (Y), and black (K). Alternatively, the print mechanism 170 may be an electrophotographic print mechanism that prints an image on a recording medium using toner contained in a toner cartridge as a color material.

The MFP 100B is a printer to be used in place of the MFP 100A in a case where a failure such as a breakdown occurs in the MFP 100A described above, for example. The MFP 100B includes the same configurations 110 to 180 (not shown) as the MFP 100A. The description of the configuration of the MFP 100B is omitted. Hereinafter, the MFP 100A is also referred to as an “old MFP”, and the MFP 100B is also referred to as a “new MFP”.

The MFP 100A is connected to, for example, a local area network LN, and is connected to the Internet IT via the local area network LN. The MFP 100B is not connected to the local area network LN in FIG. 1, but when used in place of the MFP 100A, the MFP 100B is connected to the local area network LN and is connected to the Internet IT via the local area network LN.

The terminal apparatus 200 is a computer of the user of the MFPs 100A and 100B, and is, for example, a personal computer or a smartphone. The terminal apparatus 200 includes a CPU 210 as a controller of the terminal apparatus 200, a volatile memory 220 such as a RAM, and a non-volatile memory 230 such as a hard disk drive or a flash memory. The terminal apparatus 200 includes a display 240 such as a liquid crystal display for displaying an image, an operation interface 250 such as a mouse and a keyboard for acquiring an operation by the user, and a wired or wireless communication interface 280 for connecting to the local area network LN and the Internet IT.

The CPU 210 is a computing device (processor) that performs data processing. The volatile memory 220 provides a buffer area for temporarily storing various intermediate data generated when the CPU 210 performs processing. The non-volatile memory 230 stores an application program AP.

The CPU 210 functions as a print application for causing a printer (for example, the MFP 100A) to perform printing by executing the application program AP. For example, the print application transmits a print job to a printer connected to the local area network LN in response to an instruction from the user. A port name described later is used as destination information indicating the transmission destination of the print job.

The server 300 is, for example, a computer operated by a business operator that manufactures or sells the MFPs 100A and 100B, and is, for example, a cloud server. The server 300 includes a CPU 310 as a controller of the server 300, a volatile memory 320 such as a DRAM, a non-volatile memory 330 such as a hard disk or a flash memory, and a wired or wireless communication interface 380 for connecting to the Internet IT. The server 300 is connected to the Internet IT. Thus, the server 300 communicates with each of the MFPs 100A and 100B via the Internet IT.

The CPU 310 is a computing device (processor) that performs data processing. The volatile memory 320 provides a buffer area for temporarily storing various intermediate data generated when the CPU 310 performs processing. The non-volatile memory 330 stores a computer program PGs and a management database DB.

The computer program PGs is provided in a form of being uploaded by the business operator operating the server 300, for example. The server 300 (the CPU 310) executes the computer program PGs to perform the handover related process described later in cooperation with the MFPs 100A and 100B.

The management database DB stores various data (described later) necessary for the handover related process.

Although only the MFPs 100A and 100B are shown in FIG. 1, the server 300 communicates with a large number of printers (MFPs or printers) to provide the same service. In the following, processes related to the MFPs 100A and 100B will be described, but these processes are also performed with other MFPs and printers.

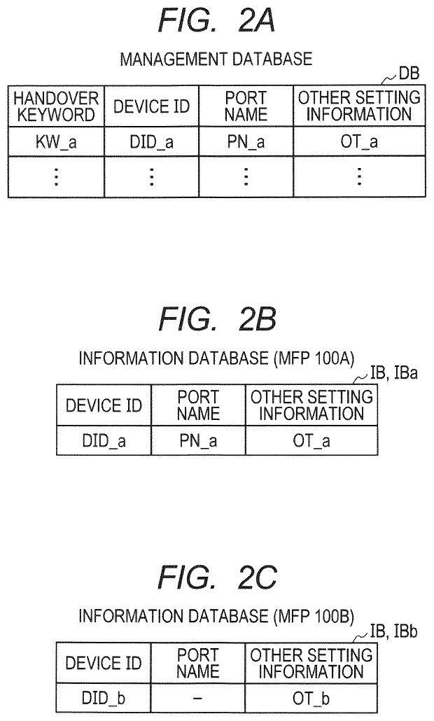

The management database DB and the information database IB will be described. The management database DB stored in the non-volatile memory 330 of the server 300 and the information database IB stored in the non-volatile memory 130 of the MFP 100A will be described. FIG. 2A is an explanatory diagram of the management database DB. FIGS. 2B and 2C are explanatory diagrams of the information database IB.

In the management database DB in FIG. 2A, a device ID, a port name, and setting information other than the port name (hereinafter, also referred to as other setting information) are stored in association with a handover keyword. In the example of FIG. 2A, a device ID “DID_a” of the MFP 100A, a port name “PN_a” of the MFP 100A, and other setting information “OT_a” are stored in association with a handover keyword “KW_a” assigned to the MFP 100A.

The handover keyword is information generated and used in a handover related process described later, and is, for example, a character string including a plurality of characters generated at random. The device ID is identification information for identifying a device (for example, a printer or an MFP). The device ID is, for example, a serial number or a MAC address.

The port name is address information indicating a device (for example, the MFP 100A) in a local area network. In other words, the port name is identification information different from the device ID, and is identification information used by the terminal apparatus to identify the printer when performing communication between the terminal apparatus (for example, the terminal apparatus 200) and the printer (for example, the MFP 100A). For example, the terminal apparatus 200 transmits a print job to a printer having the port name “PN_a” by designating the port name “PN_a” and transmitting the print job to the local area network LN. In order to correctly designate one communication destination, the port name is set so as to be unique among the devices connected to the local area network LN. In the present embodiment, the port name “PN_a” of the MFP 100A is created based on the MAC address of the MFP 100A. For example, a character string obtained by adding a particular character string to the MAC address is used as the port name. The port name is used, for example, when an operating system (OS) of the terminal apparatus is Windows, and is also referred to as a “NetBIOS name”. The “Windows” is a registered trademark of Microsoft Corporation.

The other setting information includes, for example, print setting information related to printing, scan setting information related to scanning, and communication setting information related to communication via a network. The print setting information includes various setting information related to a sheet, a print mode, and so on, set by the user. The scan setting information includes various setting information related to a reading (scanning) resolution, a storage format of scan data, and so on, set by the user. The communication setting information includes various setting information such as an IP address of a device and a mail address of the user.

As shown in FIG. 2B, the information database IB of the MFP 100A stores setting information of the MFP 100A. As shown in FIG. 2C, the information database IB of the MFP 100B stores setting information of the MFP 100B. Hereinafter, the information database IB of the MFP 100A is also referred to as an information database IBa, and the information database IB of the MFP 100B is also referred to as an information database IBb.

For example, in the information database IBa of the MFP 100A in FIG. 2B, the device ID “DID_a” of the MFP 100A, the port name “PN_a” of the MFP 100A, and the other setting information “OT_a” are stored. As will be described later, in a case where the MFP 100A receives a handover keyword from the server 300, the handover keyword is stored in the information database IBa of the MFP 100A, but in the example of FIG. 2B, the above-described handover keyword is not stored in the information database IBa.

For example, in the information database IBb of the MFP 100B in FIG. 2C, a device ID “DID_b” and other setting information “OT_b” are stored. The MFP 100B is in an initial state at the time of start of the handover related process described later. In the initial state, as shown in FIG. 2C, the information database IBb stores, for example, the other setting information “OT_b” indicating the initial setting, and does not store a port name because no port name is set.

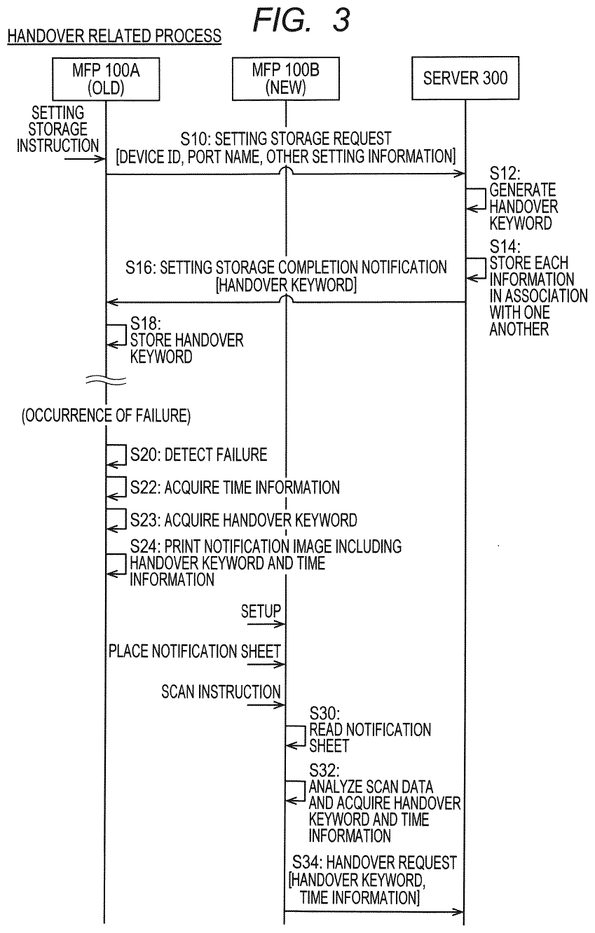

A handover related process will be described. For example, it is assumed that, in a case where the MFP 100A which is currently used has a failure, the user purchases the new MFP 100B in order to replace the MFP 100A. In such a case, the user may want to hand over (transfer) the setting information of the MFP 100A to the MFP 100B. For example, in a case where the user is using a print service (for example, a management service of a printing material) using the MFP 100A, the user may want to continue to use the print service using the MFP 100B. In such a case, the setting information related to the print service needs to be handed over to the MFP 100B. Hereinafter, the handover related process of handing over the setting information from the MFP 100A to the MFP 100B will be described. FIGS. 3 to 5 are sequence diagrams of the handover related process.

In the present embodiment, the setting information of the MFP 100A is saved in the server 300 before the MFP 100A fails. For example, the user starts using the MFP 100A, performs settings in the MFP 100A according to the user's needs, and then inputs a setting storage instruction to the MFP 100A. The setting storage instruction is an instruction to store the setting information of the MFP 100A in the server 300. The setting storage instruction is input by the user performing a particular operation on the operation interface 150 of the MFP 100A. It is assumed that, at the time when the setting storage instruction is input to the MFP 100A, the information database IBa of the MFP 100A is in the state shown in FIG. 2B described above.

When the setting storage instruction is input, in S10 the MFP 100A (CPU 110) transmits a setting storage request to the server 300. The setting storage request includes information to be stored, that is, the setting information stored in the information database IBa. In the present embodiment, the setting storage request includes the device ID “DID_a”, the port name “PN_a”, and the other setting information “OT_a” (FIG. 2B).

Note that communication between the MFP 100A and the server 300 is performed using, for example, HTTP (Hypertext Transfer Protocol). That is, the MFP 100A transmits data to the server 300 as an HTTP request, and the server 300 transmits data to the MFP 100A as an HTTP response in response to the HTTP request that has been received immediately before transmitting the HTTP response. Alternatively, the communication between the MFP 100A and the server 300 may be communication according to another protocol, for example, communication using always-on connection according to XMPP (extensible Messaging and Presence Protocol).

In response to receiving the setting storage request, in S12 the server 300 generates the handover keyword “KW_a” to be assigned to the MFP 100A. For example, the server 300 randomly selects a particular number of characters to generate a character string including the particular number of characters as the handover keyword.

In S14, the server 300 stores each information in association with one another. Specifically, the server 300 stores the information to be stored. That is, the server 300 stores the handover keyword “KW_a” generated in S12, and the device ID “DID_a”, the port name “PN_a”, and the other setting information “OT_a” included in the setting storage request received in S10 in the management database DB in association with one another (FIG. 2A).

In S16, the server 300 transmits a setting storage completion notification indicating that the storage of the setting information is completed to the MFP 100A which is the transmission source of the setting storage request. The setting storage completion notification includes the handover keyword “KW_a” that has been generated in S12.

In response to receiving the setting storage completion notification, in S18, the MFP 100A stores the handover keyword “KW_a” included in the received setting storage completion notification. That is, the MFP 100A stores the handover keyword “KW_a” in the information database IB.

The processing of S10 to S16 may be performed automatically each time the setting information is changed in the MFP 100A, for example. Alternatively, the processing of S10 to S16 may be performed in response to a user's instruction. The processing of S10 to S16 may be repeatedly performed periodically (for example, once a day at a fixed time), or may be performed when a state transition from an offline state to an online state occurs in the MFP 100A.

It is assumed that a particular type of failure occurs in the MFP 100A in a state where the setting information of the MFP 100A is stored in the management database DB of the server 300. The particular type of failure is, for example, a failure that requires replacement or repair of the MFP 100A, and in some cases, may require replacement of the MFP 100A (a purchase of a new device). The particular type of failure includes, for example, a failure that has occurred in an important part such as a power supply device (not shown), the print mechanism 170, and the scan mechanism 160.

When a particular type of failure occurs, in S20 the MFP 100A detects the failure. The detection of the failure is performed based on, for example, various signals transmitted from a sensor (not shown) provided for detection of the failure, the print mechanism 170, and the scan mechanism 160.

When the particular type of failure is detected, in S22, the MFP 100A acquires time information (date and time information) indicating the current date and time by using a clock function included in the MFP 100A. In S23, the MFP 100A acquires the handover keyword “KW_a” stored in S18 from the information database IB.

In S24, the MFP 100A prints a notification image NI including the time information and the handover keyword “KW_a”. Specifically, the MFP 100A generates print data indicating the notification image NI by using the time information acquired in S22 and the handover keyword “KW_a” acquired in S23. The MFP 100A controls the print mechanism 170 to print the notification image NI on a print medium such as a sheet by using the print data. The sheet on which the notification image NI is printed is also referred to as a notification sheet.

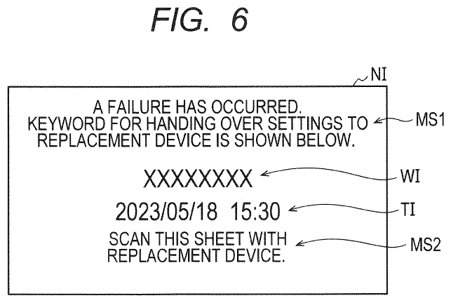

FIG. 6 is a diagram showing an example of the notification image NI. The notification image NI includes, for example, messages MS1 and MS2, a handover keyword WI, and a date and time TI. The message MS1 in FIG. 6 indicates that a failure has occurred and that a handover keyword is notified. The message MS2 in FIG. 6 indicates that the notification sheet should be scanned by a replacement device in order to hand over the setting to the replacement device. The handover keyword WI is, for example, the handover keyword “KW_a” acquired in S23 described above. The date and time TI is, for example, the date and time indicated by the time information acquired in S22 described above.

In a case where the user uses the replacement device instead of the failed MFP 100A and wants to hand over the setting information of the MFP 100A to the replacement device, the user operates the replacement device to scan the notification sheet. In a case where the user repairs the failed MFP 100A and uses the MFP 100A or in a case where the user uses the replacement device but does not hand over the setting information of the MFP 100A to the replacement device, the user does not use the notification sheet.

Hereinafter, a case where the MFP 100B is used as the replacement device instead of the failed MFP 100A and the setting information of the MFP 100A is handed over to the MFP 100B will be described.

The user sets up the MFP 100B purchased as the replacement device so as to communicate with the server 300. Specifically, the MFP 100B is connected to the local area network LN and is made ready to communicate with the server via the local area network LN and the Internet IT. The user then turns on the power of the MFP 100B.

Further, the user places the notification sheet on which the notification image NI in FIG. 6 is printed on the MFP 100B. Specifically, the notification sheet is placed on a document table or an ADF (Automatic Document Feeder) included in the scan mechanism 160 of the MFP 100B so as to be readable by the scan mechanism 160. In a state where the notification sheet is placed on the MFP 100B, the user inputs a scan instruction (reading instruction) of the notification sheet to the MFP 100B. The scan instruction is, for example, a scan instruction dedicated to a notification sheet, which is different from a normal scan instruction, and is input by performing a particular operation on the operation interface 150.

In response to acquiring the scan instruction to scan the notification sheet, in S30, the MFP 100B reads the notification sheet. Specifically, the MFP 100B controls the scan mechanism 160 to scan (read) the notification sheet. By this operation, the scan mechanism 160 generates scan data indicating the notification sheet, in other words, scan data indicating the notification image NI in FIG. 6.

In S32, the MFP 100B analyzes the generated scan data to acquire the handover keyword WI (the handover keyword “KW_a”) and the date and time TI included in the notification image NI. A known character recognition process is used for the analysis of the scan data.

In S34, the MFP 100B transmits, to the server 300, a handover request for requesting setting information associated with the handover keyword. The handover request includes the handover keyword “KW_a” acquired in S32 and time information indicating the date and time TI.

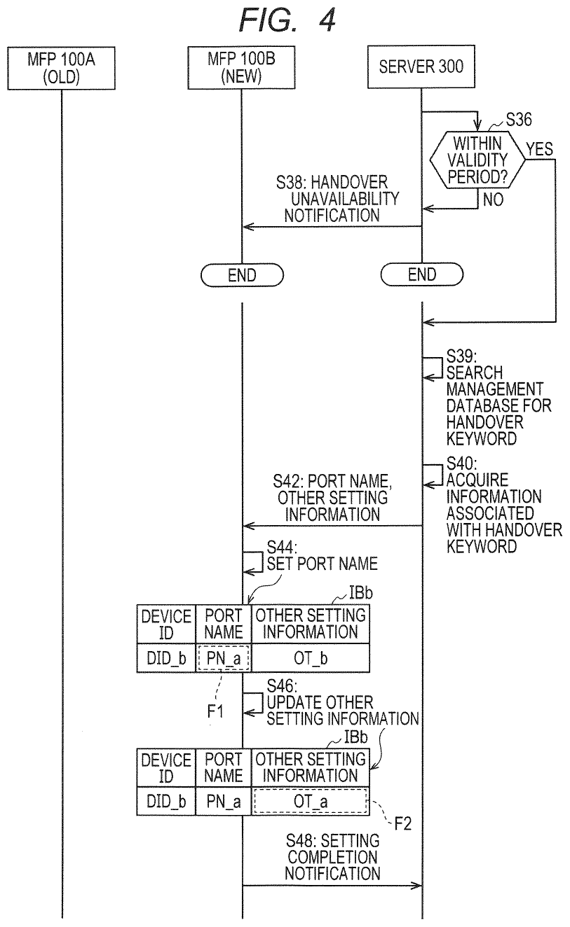

In response to receiving the handover request, in S36 in FIG. 4, the server 300 determines whether the handover request is a request within a validity period. The validity period is, for example, a period until a particular time (for example, one to two weeks) elapses from the date and time TI indicated by the time information included in the handover request. Specifically, the server 300 acquires the current date and time (that is, the date and time when the handover request is received). The server 300 identifies the validity period based on the date and time TI indicated by the time information included in the handover request. In a case where the date and time at which the handover request is received is within the identified validity period, the server 300 determines that the handover request is a request within the validity period. In a case where the date and time at which the handover request is received is outside the validity period, the server 300 determines that the handover request is not a request within the validity period.

In a case where the handover request is not a request within the validity period (S36: NO), in S38 the server 300 transmits, to the MFP 100B, a handover unavailability notification indicating that the handover of the setting information is unavailable. In this case, the handover related process is terminated without performing handover of the setting information.

In a case where the handover request is a request within the validity period (S36: YES), in S39, the server 300 searches the management database DB (FIG. 2A) for the handover keyword “KW_a” included in the handover request. In S40, the server 300 acquires information associated with the found handover keyword “KW_a” from the management database DB. As shown in FIG. 2A, the port name “PN_a” and the other setting information “OT_a” associated with the handover keyword “KW_a” are acquired from the management database DB.

In S42, the server 300 transmits the port name “PN_a” and the other setting information “OT_a”, which have been acquired in S40, to the MFP 100B.

In response to receiving the port name “PN_a” and the other setting information “OT_a”, in S44, the MFP 100B sets the port name “PN_a” received from the server 300 as the port name indicating the MFP 100B itself. Specifically, as shown by a broken line frame F1 in FIG. 4, the MFP 100B stores the port name “PN_a” in the information database IBb.

In S46, the MFP 100B updates setting information different from the port name, that is, other setting information set in the MFP 100B itself. Specifically, as indicated by a broken line frame F2 in FIG. 4, the MFP 100B changes the default other setting information “OT_b” stored in the information database IBb to the other setting information “OT_a” received from the server 300.

In S48, the MFP 100B transmits, to the server 300, a setting completion notification indicating that the setting of the port name and the other setting information is completed.

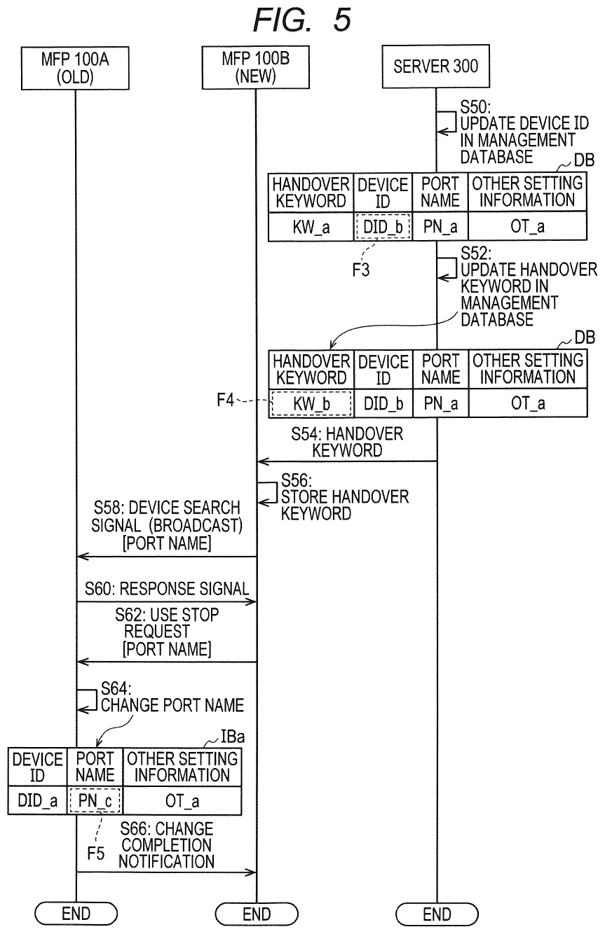

In response to receiving the setting completion notification, the server 300 updates the device_ID in the management database DB in S50. Specifically, as indicated by a broken line frame F3 in FIG. 5, the server 300 changes the device ID associated with the handover keyword “KW_a” included in the handover request received in S34 in FIG. 3 from the device ID “DID_a” of the MFP 100A to the device ID “DID_b” of the MFP 100B. That is, the association between the port name “PN_a” and the other setting information “OT_a” and the device ID “DID_a” of the MFP 100A is canceled, and the port name “PN_a” and the other setting information “OT_a” are associated with the device ID “DID_b” of the MFP 100B. By this operation, it is also recorded in the server 300 that the device using the port name “PN_a” and the other setting information “OT_a” has been changed to the MFP 100B (device ID “DID_b”).

In S52, the server 300 updates the handover keyword in the management database DB. Specifically, as indicated by a broken line frame F4 in FIG. 5, the handover keyword “KW_a” associated with the port name “PN_a” and the other setting information “OT_a” in the management database DB is changed to a new handover keyword “KW_b”. The new handover keyword “KW_b” is newly generated in this step. Thus, the handover keyword “KW_a” that has already been used for handover is invalidated. Since the handover keyword “KW_a” has been printed, for example, the handover keyword “KW_a” may be used again by the user by mistake or may be used by a person different from the user in an unauthorized manner. In this step, the handover keyword “KW_a” is invalidated, which suppresses fraudulent acquisition or erroneous acquisition of the port name “PN_a” and the other setting information “OT_a” using the handover keyword “KW_a”, for example.

In S54, the server 300 transmits the new handover keyword “KW_b” to the MFP 100B.

In response to receiving the handover keyword “KW_b”, the MFP 100B stores the handover keyword “KW_b” in S56. That is, the MFP 100B stores the handover keyword “KW_b” in the information database IBb. Thus, for example, when a particular type of failure occurs in the MFP 100B, the MFP 100B prints a notification image including the handover keyword “KW_b” as the MFP 100A performs in S23 and S24 in FIG. 3. That is, by the processing of S50 to S54, preparation for handing over the setting information including the port name “PN_a” to the next replacement device is performed in a case where the MFP 100B fails.

In S58, the MFP 100B broadcasts a device search signal to the local area network LN. The device search signal is a signal for searching for a device having the port name “PN_a” set in the MFP 100B itself, and includes the port name “PN_a”. In a case where the communication function of the MFP 100A is not broken, the MFP 100A receives the device search signal.

At this point, the port name set in the MFP 100A is identical to the port name “PN_a” set in the MFP 100B. In response to receiving the device search signal including the port name “PN_a” indicating the MFP 100A, in S60 the MFP 100A transmits, to the MFP 100B, a response signal indicating that the MFP 100A itself is a device having the port name “PN_a”. In a case where there is a device to which the same port name “PN_a” is set in the local area network LN, there is a high possibility that a communication error due to conflict of port name is detected at the time of execution of S58. Thus, in response to detecting a communication error due to the conflict of the port name during the execution of S58, the MFP 100B may perform the processing of S62 in the same manner as the case where the response signal of S60 is received.

In response to receiving the response signal, in S62, the MFP 100B transmits, to the MFP 100A, a use stop request for requesting stopping use of the port name “PN_a”. The use stop request includes the port name “PN_a”. This is because, if there are a plurality of devices using the same port name in the local area network LN, for example, there is a possibility of a problem such as that the terminal apparatus 200 is unable to designate one device to send a print job thereto and thus, it is necessary to stop the use of the port name “PN_a” by the MFP 100A. In S62, it is conceivable that, in a state where the port name of the MFP 100B is “PN_a”, the MFP 100B cannot transmit the use stop request to the MFP 100A due to a communication error due to the conflict of the port name “PN_a”. For this reason, in S62, the MFP 100B may temporarily change its own port name to a port name different from “PN_a” and then transmit the use stop request to the MFP 100A. In contrast, in a case where there is no device having the port name “PN_a” in the local area network LN, the MFP 100B does not receive the response signal. Thus, in a case where the response signal is not received within a particular period after the MFP 100B broadcasts the device search signal in S58, the MFP 100B ends the handover related process.

In response to receiving the use stop request, in S64, the MFP 100A changes the port name “PN_a” in settings stored in the information database IBa to another port name “PN_c” as indicated by a broken line frame F5 in FIG. 5 in order to stop the use of the port name “PN_a”. The other port name “PN_c” is generated, for example, according to a particular generation rule. For example, the MFP 100A generates the other port name “PN_c” by adding a particular character string to the port name “PN_a” or replacing a part of the character string of the port name “PN_a” with another character string, and stores the port name “PN_c” in the information database IBa. As a result, even if a print job specifying the port name “PN_a” as the destination is transmitted to the MFP 100A from the user's terminal apparatus 200, the MFP 100A does not receive the print job. Thus, the change of the port name can be said to be a stop process for stopping communication with the terminal apparatus 200 (for example, reception of a print job from the terminal apparatus 200) using the original port name.

In S66, the MFP 100A transmits, to the MFP 100B, a change completion notification indicating that the port name has been changed.

According to the present embodiment described above, the MFP 100A outputs the handover keyword “KW_a” assigned to the MFP 100A (an output step, S23 and S24 in FIG. 3), the MFP 100B receives an input of the handover keyword “KW_a” (an input step, S30 and S32 in FIG. 3), and the MFP 100B acquires, based on the handover keyword “KW_a”, the port name “PN_a” indicating the MFP 100A in the local area network LN to which the MFP 100A is connected (an acquisition step, S34 in FIGS. 3 to S42 in FIG. 4). Further, the MFP 100B sets the port name “PN_a” acquired in the acquisition step as the port name indicating the MFP 100B in the local area network LN (a setting step, S44 in FIG. 4), and the MFP 100B transmits the use stop request for stopping communication using the port name “PN_a” to the MFP 100A (a stop request transmission step, S62 in FIG. 5).

As a result, the MFP 100B acquires the port name “PN_a” based on the handover keyword “KW_a” output from the MFP 100A, and sets the port name “PN_a” as the port name indicating the MFP 100B in the local area network LN. As a result, the MFP 100B takes over the port name “PN_a”. Further, the MFP 100B transmits the use stop request for stopping the communication using the port name “PN_a” to the MFP 100A, which suppresses an inconvenience in which the port name “PN_a” becomes a port name indicating both the MFP 100A and the MFP 100B in the local area network LN. Thus, for example, the same communication as the communication performed between the terminal apparatus 200 and the MFP 100A in the local area network LN is performed between the terminal apparatus 200 and the MFP 100B.

Thus, even if no change is made to the settings of the terminal apparatus 200, the terminal apparatus 200 transmits a print job to the MFP 100B which is the replacement device, by simply performing the same process as the process that was performed to transmit a print job to the MFP 100A. As a result, for example, the user does not need to change the settings and so on in the terminal apparatus 200, and the burden on the user when using the MFP 100B instead of the MFP 100A is reduced. In particular, in a case where the MFP 100A is shared by a plurality of users, it is not necessary to change the settings of the terminal apparatuses 200 owned by the respective users in response to the replacement of the MFP 100A with the MFP 100B, and thus, the burden on the users is greatly reduced.

According to the present embodiment, a storage step (S14 in FIG. 3, FIG. 2A) of storing the port name “PN_a” in association with the handover keyword “KW_a” in the management database DB of the non-volatile memory 330 of the server 300 is performed. In the above-described acquisition process (S34 in FIGS. 3 to S42 in FIG. 4), the MFP 100B transmits the handover request including the handover keyword “KW_a” to the server 300 (a request step, S34 in FIG. 3), and the server 300 transmits, to the MFP 100B, the port name “PN_a” stored in the management database DB in association with the handover keyword “KW_a” in response to reception of the handover request (a transmission step, S42 in FIG. 4), whereby the MFP 100B acquires the port name “PN_a”. As a result, the port name “PN_a” of the MFP 100A is handed over to the MFP 100B via the server 300.

For example, in a case where the MFP 100A has a failure, there is a possibility that the port name “PN_a” of the MFP 100A cannot be transmitted to the MFP 100B, depending on the failure state. By storing the port name “PN_a” and the other setting information “OT_a” in the server 300 in advance, the port name “PN_a” is reliably handed over to the MFP 100B. Further, for example, even in a case where the amount of the other setting information “OT_a” is large, the other setting information “OT_a” is easily handed over to the MFP 100B.

Further, after the notification image NI is printed by the MFP 100A, the setting information is handed over between the MFP 100B and the server 300. Thus, for example, even in a case where the MFP 100A cannot communicate due to a failure, the setting information including the port name “PN_a” is handed over from the MFP 100A to the MFP 100B.

According to the present embodiment, the information output by the MFP 100A by printing includes the time information indicating the date and time TI for defining the validity period in addition to the handover keyword “KW_a” (FIGS. 6, S22 and S24 in FIG. 3). The server 300 determines whether the reception date and time of the handover request is within the validity period by using the time information (S36 in FIG. 4). The server 300 transmits the port name “PN_a” to the MFP 100B (S42 in FIG. 4) in a case where the reception date and time of the handover request is within the validity period (YES in S36 in FIG. 4), and does not transmit the port name “PN_a” to the MFP 100B in a case where the reception date and time of the handover request is outside the validity period (NO in S36 in FIG. 4). For example, once the handover keyword is printed, the printed handover keyword may be known to a person different from the user. Further, if the user wishes to hand over the setting information such as the port name “PN_a”, it is considered that the user prints the handover keyword relatively quickly and operates the MFP 100B to scan the notification sheet to perform handover. Thus, in a case where the reception date and time of the handover request is after an excessive time has elapsed since the handover keyword was printed, there is a high possibility that a person different from the user has operated his/her MFP to scan the notification sheet for the purpose of fraudulently acquiring the setting information such as the port name “PN_a”. Thus, in the present embodiment, the server 300 transmits the setting information such as the port name “PN_a” in a case where the reception date and time of the handover request is within the validity period. This reduces the possibility that the setting information that may include personal information such as an e-mail address is transmitted to a device (for example, an MFP) of a person different from the user.

According to the present embodiment, the server 300 stores the port name “PN_a” in the management database DB in association with the device ID “DID_a” of the MFP 100A (FIG. 2A, S14 in FIG. 3). After transmitting the port name “PN_a” to the MFP 100B (S42 in FIG. 4), the server 300 cancels the association between the port name “PN_a” and the device ID “DID_a” of the MFP 100A in the management database DB, and associates the port name “PN_a” with the device ID “DID_b” of the MFP 100B (S50 in FIG. 5). Accordingly, the server 300 also manages (stores) that the port name “PN_a” is the port name of the MFP 100B. For example, in a case where the port name “PN_a” is subsequently handed over to another MFP or printer, the server 300 transmits a use stop request to stop using the port name “PN_a” to the MFP 100B.

According to the present embodiment, the server 300 generates the handover keyword “KW_a” (S12 in FIG. 3), and stores the port name “PN_a” in the management database DB in association with the generated handover keyword “KW_a” (S14 in FIG. 3). The server 300 further transmits the generated handover keyword “KW_a” to the MFP 100A (S16 in FIG. 3). As a result, the server 300 manages the setting information such as the port name “PN_a” of the MFP 100A in association with the handover keyword “KW_a” generated by the server 300 itself. Further, by receiving the handover keyword “KW_a” from the server 300, the MFP 100A prints the notification image NI including the handover keyword “KW_a” at the time of failure.

According to the present embodiment, the MFP 100A detects a failure of the MFP 100A itself (S20 in FIG. 3), and, in response to detecting a failure of the MFP 100A, outputs the handover keyword “KW_a” (prints the notification image NI including the handover keyword “KW_a”). As a result, in a case where a failure occurs in the MFP 100A, the setting information such as the port name “PN_a” of the MFP 100A is handed over to the MFP 100B. According to the present embodiment, the MFP 100B transmits a search signal for determining whether a device (for example, the MFP 100A) using the same port name “PN_a” as the MFP 100B itself exists, in the local area network LN (S58 in FIG. 5). In a case where it is found by the search signal that there is a device (for example, the MFP 100A) using the port name “PN_a” (S60 in FIG. 5), the MFP 100B transmits the use stop request to the device (S62 in FIG. 5). This more reliably avoids an inconvenience that the MFP 100A transmits the search signal to the local area network LN and the port name “PN_a” is used as information indicating a plurality of devices in the local area network LN.

According to the present embodiment, the handover keyword “KW_a” is output by the MFP 100A printing the notification image NI including the handover keyword “KW_a” on a print medium. The handover keyword “KW_a” is input by the MFP 100B acquiring scan data that is generated by optically reading the print medium (the notification sheet in the present embodiment) on which the notification image NI is printed. As a result, for example, even when the MFP 100A is in a state in which communication cannot be performed due to a failure, the MFP 100A outputs the handover keyword “KW_a” and the MFP 100B receives the handover keyword “KW_a”.

According to the present embodiment, as described above, when the terminal apparatus 200 transmits a print job to the local area network LN, the port name “PN_a” is used as information indicating the transmission destination of the print job. Thus, the print job transmitted from the terminal apparatus 200 to the port name “PN_a” as the transmission destination is received by the MFP 100A before the handover related process is performed, and is received by the MFP 100B after the handover related process is performed. As a result, this enables the user to use the MFP 100B as the replacement device when the MFP 100A has a failure, in printing using the terminal apparatus 200.

As can be understood from the above description, the MFP 100A of the present embodiment is an example of a first printer, and the MFP 100B is an example of a second printer. The handover keyword “KW_a” of the present embodiment is an example of particular information, and the port name “PN_a” is an example of particular destination information. The device ID “DID_a” of the present embodiment is an example of first identification information, and the device ID “DID_b” is an example of second identification information.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described present disclosure are provided below.

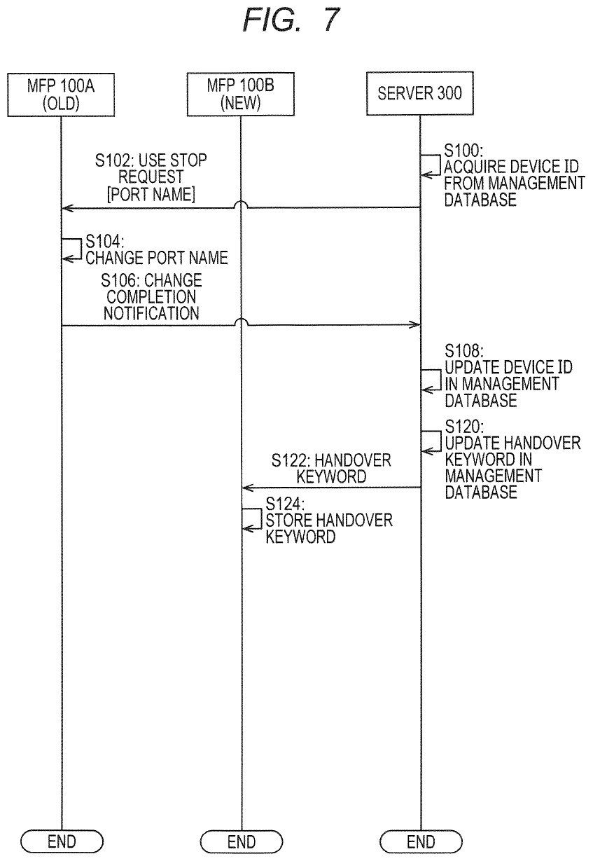

(1) In the above-described embodiment, the use stop request is transmitted from the MFP 100B to the MFP 100A (S62 in FIG. 5). Alternatively, the use stop request may be transmitted from the server 300 to the MFP 100A. FIG. 7 is a sequence diagram of a handover related process of a modification. In the modification, S100 to S124 in FIG. 7 are performed instead of S50 to S66 in FIG. 5. Other processes of the modification are the same as the processes of the embodiment (for example, the processes in FIGS. 3 and 4).

In S100, the server 300 acquires, from the management database DB, the device ID of the device to which a use stop request is to be transmitted (in the present modification, the MFP 100A). For example, the server 300 acquires the device ID “DID_a” (FIG. 2A) that is associated with the handover keyword “KW_a” included in the handover request received in S34 in FIG. 3.

In S102, the server 300 transmits a use stop request for requesting stopping the use of the port name “PN_a” to the MFP 100A. For example, in the present modification, while the power of the MFP 100A is turned on, always-on connection such as XMPP is established between the MFP 100A and the server 300. The use stop request is transmitted using the always-on connection.

In response to receiving the use stop request, in S104, the MFP 100A changes the port name “PN_a” in settings stored in the information database IBa to another port name “PN_c” in order to stop the use of the port name “PN_a”. The processing of S104 is identical to the processing of S64 in FIG. 5 in the embodiment.

In S106, the MFP 100A transmits, to the server 300, a change completion notification indicating that the port name has been changed.

In response to receiving the change completion notification, in S108, the server 300 updates the device ID in the management database DB. That is, as in S50 in FIG. 5, as indicated by the broken line frame F3 in FIG. 5, the server 300 changes the device ID associated with the handover keyword “KW_a” included in the handover request received in S34 in FIG. 3 from the device ID “DID_a” of the MFP 100A to the device ID “DID_b” of the MFP 100B.

In S120, the server 300 updates the handover keyword in the management database DB. That is, as in S52 in FIG. 5, as indicated by the broken line frame F4 in FIG. 5, the server 300 changes the handover keyword “KW_a” associated with the port name “PN_a” and the other setting information “OT_a” to a new handover keyword “KW_b” in the management database DB.

In S122, the server 300 transmits the new handover keyword “KW_b” to the MFP 100B, similarly to S54 in FIG. 5.

In response to receiving the handover keyword “KW_b”, in S124 the MFP 100B stores the handover keyword “KW_b”, similarly to S56 in FIG. 5.

According to the above-described modification, in response to receiving the handover request (S34 in FIG. 3), the server 300 transmits the use stop request to the MFP 100A identified by the device ID “DID_a” associated with the port name “PN_a” in the management database DB (S102 in FIG. 7). In this way, the server 300 transmits the use stop request to the MFP 100A, which suppresses an inconvenience in which the port name “PN_a” is used as information indicating both the MFP 100A and the MFP 100B in the local area network LN. According to the present modification, even in a case where the MFP 100B is not provided with a capability of transmitting the use stop request to the MFP 100A, the MFP 100A is caused to stop the use of the port name “PN_a”.

(2) In the above-described embodiment, as the stopping process for stopping the use of the port name “PN_a”, the MFP 100A changes the port name of the MFP 100A (S64 in FIG. 5). Alternatively, the MFP 100A may perform, as the stopping process, a process of setting to prohibit reception of a print job. Alternatively, the MFP 100A may perform, as the stopping process, a process of setting to prohibit printing by the print mechanism 170.

(3) In the above-described embodiment, the MFP 100A outputs the particular information by printing the notification image NI including the particular information (specifically, the handover keyword “KW_a”) (S24 in FIG. 3). Alternatively, the MFP 100A may output the particular information by displaying the particular information on the display 140. Alternatively, the MFP 100A may output the particular information by wireless communication such as Bluetooth. Instead of outputting the particular information as it is, the MFP 100A may encrypt the particular information by a particular encryption method and then output (for example, print, display, or communicate) the encrypted particular information, or may encode the particular information into a two dimensional code (for example, a QR Code) or a one dimensional code (for example, a barcode) and then output (for example, print or display) the encoded particular information. The “Bluetooth” is a registered trademark of Bluetooth SIG, Inc. The “QR Code” is a registered trademark of DENSO WAVE INCORPORATED.

(4) In the above-described embodiment, the MFP 100B receives an input of the particular information by reading the notification image NI including the particular information. Instead, the MFP 100B may receive an input of the particular information by a user's operation via the operation interface 150, for example. For example, in a case where a single-function printer without a scan mechanism is used instead of the MFP 100B, scan data representing the notification image NI including the particular information may be generated by a single-function scanner connected to the local area network LN, and the single-function printer may receive the scan data from the single-function scanner via the local area network LN. The MFP 100B may receive the particular information from the user's terminal apparatus 200 (for example, a smartphone) via the local area network LN. The terminal apparatus 200 may receive the particular information to be transmitted to the MFP 100B by an input operation of the user or by capturing the notification image NI including the particular information with a digital camera.

(5) In the above-described embodiment, the setting information including the port name “PN_a” is handed over from the MFP 100A to the MFP 100B via the server 300. Alternatively, the setting information including the port name “PN_a” may be handed over from the MFP 100A to the MFP 100B without the intervention of the server 300. In this case, for example, the MFP 100A prints a print image including all the setting information to be handed over including the port name “PN_a” on a sheet. The MFP 100B reads the notification image by the scan mechanism 160 to generate scan data and acquire the scan data. The MFP 100B analyzes the scan data by a known character recognition process to acquire the setting information including the port name “PN_a”, and stores the setting information in the information database IBb. In this modification, the print image indicating the setting information including the port name “PN_a” is an example of the particular information.

(6) In the above-described embodiment, the particular information used for the handover of the setting information including the port name “PN_a” is the handover keyword “KW_a”. The particular information used for the handover is not limited to the handover keyword “KW_a”, and may be unique information assigned to the MFP 100A, for example, the device ID “DID_a” of the MFP 100A.

(7) The handover related process of the above-described embodiment is an example, and steps may be modified or omitted as appropriate. For example, in S24 in FIG. 3, the MFP 100A prints the notification image NI including the handover keyword and the time information, but may print the notification image NI including the handover keyword and not including the time information. In this case, S36 and S38 in FIG. 4 are omitted, and S39 in FIG. 4 is performed after S34 in FIG. 3.

(8) In the above-described embodiment, the processing related to setting of the port name (S44 to S48 in FIG. 4), the processing related to updating of the management database (S50 to S56 in FIG. 5), and the processing related to stopping of the use (S58 to S66 in FIG. 5) are performed in this order, but the order of these processing may be changed. Specifically, after the MFP 100B receives the port name and other setting information in S42 in FIG. 4, the MFP 100A and the MFP 100B perform the processing related to stopping of the use (S58 to S66 in FIG. 5). After the processing related to stopping of the use (S56 to S66 in FIG. 5) is performed, the MFP 100A and the server 300 perform the processing related to the setting of the port name (S44 to S48 in FIG. 4). Further, after the processing related to the setting of the port name (S44 to S48 in FIG. 4) is performed, the server 300 and the MFP 100B perform processing related to the update of the management database (S50 to S56 in FIG. 5). This eliminates a period in which the port name “PN_a” is temporarily used (shared) by two devices, which suppresses the occurrence of a malfunction caused by the shared port name “PN_a”.

(9) In the above-described embodiment, by performing the processing from S50 to S54 in FIG. 5, preparations for handing over the setting information including the port name “PN_a” to the next replacement device are performed in preparation for a case in which the MFP 100B fails. Alternatively, S50 to S54 in FIG. 5 may be omitted. In this case, for example, after the handover related process, the MFP 100B and the server 300 may perform processing similar to the processing performed by the MFP 100A and the server 300 in S10 to S18 in FIG. 3 to prepare for handing over the setting information including the port name “PN_a” to the next replacement device.

(10) In the above-described embodiment, the server 300 generates the handover keyword and transmits the handover keyword to the MFP 100A (S12 and S16 in FIG. 3). Alternatively, the MFP 100A may generate the handover keyword and transmit the generated handover keyword to the server 300 together with the setting storage request in S10 in FIG. 3.

(11) In the above-described embodiment, the MFP 100A prints the notification image NI including the handover keyword when a failure occurs in the MFP 100A. Alternatively, the MFP 100A may print the notification image NI including the handover keyword, for example, when a print instruction of the user is input. In this case, even if the MFP 100A does not have a failure, for example, when the user purchases the new MFP 100B and wants to replace the MFP 100A with the MFP 100B, the setting information including the port name “PN_a” is easily handed over from the MFP 100A to the MFP 100B.

(12) One or both of the MFP 100A and the MFP 100B of the above-described embodiment may be a single-function printer that does not include an image scan mechanism and includes a print mechanism.

(13) In the above-described embodiment, the setting information of the MFP including the port name “PN_a” is handed over from the MFP 100A to the MFP 100B. Not limited to this, various information related to the MFP may be handed over from the MFP 100A to the MFP 100B. For example, in a case where the MFP 100A provides a particular service provided by the server 300, service information regarding the particular service may be handed over from the MFP 100A to the MFP 100B. The service information may include information indicating the type of service and information indicating the usage history of the service. The particular service may be a service of various types, and for example, may be a printing material management service in which the user pays a fixed amount of fee every month and the server 300 manages the consumption amount of printing material such as ink in the MFP and automatically orders the printing material according to consumption of the printing material in the MFP. The print service may be a service for performing remote printing by transmitting a print job from the terminal apparatus 200 to the server 300 and transmitting the print job from the server 300 to the MFP by using always-on connection.

(14) In the above-described embodiment, a part of the configuration realized by hardware may be replaced by software, and conversely, a part or all of the configuration realized by software may be replaced by hardware.

What is claimed is:

1. A method performed with a first printer and a second printer to be used in place of the first printer, the method comprising:
outputting, by the first printer, particular information relating to the first printer;
receiving, by the second printer, an input of the particular information;
acquiring, by the second printer, particular destination information based on the particular information, the particular destination information indicating the first printer in a local area network to which the first printer is connected;
setting, by the second printer, the particular destination information as destination information indicating the second printer in the local area network; and
transmitting a use stop request from the second printer or a server to the first printer, the use stop request being a request for stopping communication using the particular destination information, the server being configured to communicate with the first printer.

2. The method according to claim 1, further comprising:
storing, in a memory of the server, the particular destination information in association with the particular information,
wherein the acquiring includes:
transmitting information request from the second printer to the server, the information request including the particular information, the information request requesting the particular destination information; and
in response to receiving the information request by the server, transmitting the particular destination information from the server to the second printer, the particular destination information being stored in association with the particular information.

3. The method according to claim 2, wherein the outputting includes further outputting time information for defining a validity period of the particular information; and
wherein the transmitting the particular destination information includes:
determining, by the server, whether a receipt date and time of the information request is within the validity period by using the time information;
transmitting the particular destination information from the server to the second printer in response to determining that the receipt date and time of the information request is within the validity period; and
not transmitting the particular destination information from the server to the second printer in response to determining that the receipt date and time of the information request is outside the validity period.

4. The method according to claim 2, wherein the storing includes storing the particular destination information in association with first identification information identifying the first printer; and
wherein the method further comprises:
after transmitting the particular destination information, cancelling, by the server, association between the particular destination information and the first identification information stored in the memory and associating the particular destination information with second identification information identifying the second printer.

5. The method according to claim 2, wherein the storing includes generating the particular information by the server and storing the particular destination information in the memory in association with the generated particular information; and
wherein the method further comprises transmitting the particular information from the server to the first printer.

6. The method according to claim 1, further comprising detecting a failure of the first printer,
wherein the particular information is output in response to detecting the failure of the first printer.

7. The method according to claim 1, further comprising:
transmitting a search signal from the second printer to the local area network, the search signal being a signal for searching for a printer using same destination information as the particular destination information,
wherein the transmitting the use stop request includes:
in response to finding the printer using the same destination information, transmitting the use stop request to the printer using the same destination information.

8. The method according to claim 2, wherein the storing includes storing the particular destination information in association with first identification information identifying the first printer; and
wherein the transmitting the use stop request includes:
in response to receiving the information request by the server, transmitting the use stop request from the server to the first printer identified by the first identification information associated with the particular destination information.

9. The method according to claim 1, wherein the outputting includes printing, by the first printer, a particular image including the particular information on a print medium; and
wherein the receiving includes acquiring scan data that is generated by optically reading the print medium on which the particular image is printed.

10. The method according to claim 1, wherein the particular destination information is used as information indicating a transmission destination of a print job when a terminal apparatus transmits the print job to the local area network;
wherein, before setting the particular destination information as the destination information indicating the second printer and transmitting the use stop request to the first printer, the print job transmitted from the terminal apparatus to the particular destination information is received by the first printer; and
wherein, after setting the particular destination information as the destination information indicating the second printer and transmitting the use stop request to the first printer, the print job transmitted from the terminal apparatus to the particular destination information is received by the second printer.

11. A communication system comprising:
a first printer; and
a second printer to be used in place of the first printer,
the first printer configured to:
output particular information relating to the first printer,
the second printer configured to:
receive an input of the particular information;
acquire particular destination information based on the particular information, the particular destination information indicating the first printer in a local area network to which the first printer is connected; and
set the particular destination information as destination information indicating the second printer in the local area network,
the second printer or a server configured to:
transmit, to the first printer, a use stop request for stopping communication using the particular destination information, the server being configured to communicate with the first printer.

12. The communication system according to claim 11, wherein the server is configured to store, in a memory of the server, the particular destination information in association with the particular information;
wherein the second printer is configured to:
transmit information request to the server, the information request including the particular information, the information request requesting the particular destination information; and
wherein the server is configured to:
in response to receiving the information request, transmit the particular destination information to the second printer, the particular destination information being stored in association with the particular information.

13. The communication system according to claim 12, wherein the first printer is configured to further output time information for defining a validity period of the particular information; and
wherein the server is configured to:
determine whether a receipt date and time of the information request is within the validity period by using the time information;
transmit the particular destination information to the second printer in response to determining that the receipt date and time of the information request is within the validity period; and
not transmit the particular destination information to the second printer in response to determining that the receipt date and time of the information request is outside the validity period.

14. The communication system according to claim 12, wherein the server is configured to:
store the particular destination information in association with first identification information identifying the first printer; and
after transmitting the particular destination information, cancel association between the particular destination information and the first identification information stored in the memory and associate the particular destination information with second identification information identifying the second printer.

15. The communication system according to claim 12, wherein the server is configured to:
generate the particular information and store the particular destination information in the memory in association with the generated particular information; and
transmit the particular information to the first printer.

16. The communication system according to claim 11, wherein the first printer is configured to:
detect a failure of the first printer; and
output the particular information in response to detecting the failure of the first printer.

17. The communication system according to claim 11, wherein the second printer is configured to transmit a search signal to the local area network, the search signal being a signal for searching for a printer using same destination information as the particular destination information; and
wherein the second printer or the server is configured to:
in response to finding the printer using the same destination information, transmit the use stop request to the printer using the same destination information.

18. The communication system according to claim 12, wherein the server is configured to:
store the particular destination information in association with first identification information identifying the first printer; and
in response to receiving the information request, transmit the use stop request to the first printer identified by the first identification information associated with the particular destination information.

19. The communication system according to claim 11, wherein the first printer is configured to print a particular image including the particular information on a print medium; and
wherein the second printer is configured to acquire scan data that is generated by optically reading the print medium on which the particular image is printed.

20. The communication system according to claim 11, wherein the particular destination information is used as information indicating a transmission destination of a print job when a terminal apparatus transmits the print job to the local area network;
wherein, before setting the particular destination information as the destination information indicating the second printer and transmitting the use stop request to the first printer, the print job transmitted from the terminal apparatus to the particular destination information is received by the first printer; and
wherein, after setting the particular destination information as the destination information indicating the second printer and transmitting the use stop request to the first printer, the print job transmitted from the terminal apparatus to the particular destination information is received by the second printer.
